(19) United States
(12) Patent Application Publication
(10) Pub. No.: US 2024/0329655 A1
(43) Pub. Date: Oct. 3, 2024

(54) INFORMATION PROCESSING DEVICE, MOVABLE APPARATUS, INFORMATION PROCESSING METHOD, AND STORAGE MEDIUM

(71) Applicant: CANON KABUSHIKI KAISHA, Tokyo (JP)

(72) Inventors: SONOKO MIYATANI, Tokyo (JP); MASAKAZU FUJIKI, Kanagawa (JP)

(21) Appl. No.: 18/623,810

(22) Filed: Apr. 1, 2024

(30) Foreign Application Priority Data
Apr. 3, 2023 (JP) 2023-059808

(51) Int. Cl. G05D 1/246; G05D 1/648; G05D 105/80

(52) U.S. Cl. CPC G05D 1/2465; G05D 1/648; G05D 2105/87

(57) ABSTRACT

An information processing device includes a position and orientation measurement unit to calculate a position and an orientation of a movable apparatus based on measurement information of a first sensor that measures an environment in surroundings of the movable apparatus. A first environment map is created in a vicinity of the movable apparatus based on the measurement information of the first sensor and the position and the orientation, and a second environment map to be merged with the first environment maps determined. Information regarding the second environment map is acquired and a traveling path of the movable apparatus is determined to merge the first environment map and the second environment map based on the information regarding the second environment map.

### BACKGROUND

### Field of the Disclosure

The present disclosure relates to an information processing device, a movable apparatus, an information processing method, a storage medium, and the like.

### Description of the Related Art

As a method of estimating a position and an orientation of a movable apparatus from information acquired by a camera or a sensor such as a distance sensor mounted in the movable apparatus, a simultaneous localization and mapping (SLAM) technique is known. According to SLAM, self-position and orientation estimation using a three-dimensional environment map for recognizing information regarding positions of objects in the surroundings is performed.

However, since a broad environment map is needed in a case where a moving range of the movable apparatus is wide, it takes a long time to create the environment map. As a method of efficiently creating a large environment map, Japanese Patent Laid-Open No. 2013-109325 discloses a method of creating an entire environment map by dividing a search section of each robot based on a relative position and orientation of each robot and merging map information acquired by each robot.

However, Japanese Patent Laid-Open No. 2013-109325 does not take accuracy of merging the created environment map group into consideration. Therefore, the plurality of environment maps may not be able to be merged with high accuracy.

### SUMMARY OF THE DISCLOSURE

An information processing device according to one aspect of the disclosure includes at least one processor or circuit configured to function as: a position and orientation measurement unit configured to calculate a position and an orientation of a movable apparatus based on measurement information of a sensor that measures an environment in surroundings of the movable apparatus; an environment map creation unit configured to create a first environment map in a vicinity of the movable apparatus based on the measurement information of the sensor and the position and the orientation; an environment map determination unit configured to determine a second environment map to be merged with the first environment map; an environment map acquisition unit configured to acquire information regarding the second environment map; and a path determination unit configured to determine a traveling path of the movable apparatus to merge the first environment map and the second environment map based on the information regarding the second environment map.

Further features of the present disclosure will become apparent from the following description of embodiments with reference to the attached drawings.

### BRIEF DESCRIPTION OF THE DRAWINGS

FIGS. 1A and 1B are diagrams for explaining accuracy of merging environment maps.

FIG. 2 is a diagram illustrating an example of a utilization scene according to a first embodiment.

FIG. 3 is a functional block diagram illustrating a configuration example of an information processing system according to the first embodiment.

FIG. 4 is a diagram illustrating a hardware configuration of an information processing device 300 according to the first embodiment.

FIG. 5 is a flowchart illustrating a position and orientation measurement processing example according to the first embodiment.

FIG. 6 is a flowchart illustrating a path determination processing example according to the first embodiment.

FIG. 7 is a functional block diagram illustrating a configuration example of an information processing system according to a second embodiment.

FIG. 8 is a flowchart illustrating a path determination processing example according to the second embodiment.

FIG. 9 is a diagram illustrating an example of a screen indicating environment maps to be merged and information regarding a traveling path added for the merging.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

In general, merging of a plurality of environment maps is performed on the basis of information common to the environment maps. Information held by the environment maps includes images captured by a sensor when the environment maps are created, image features extracted from the images, a position and an orientation of the sensor at the time of imaging, and the like.

The information common to the environment maps includes similar images and image features that are similar among the environment maps, the position and the orientation of the sensor when these images are captured, and the like. Accuracy of merging the environment maps depends on the amount and the distribution of the common information.

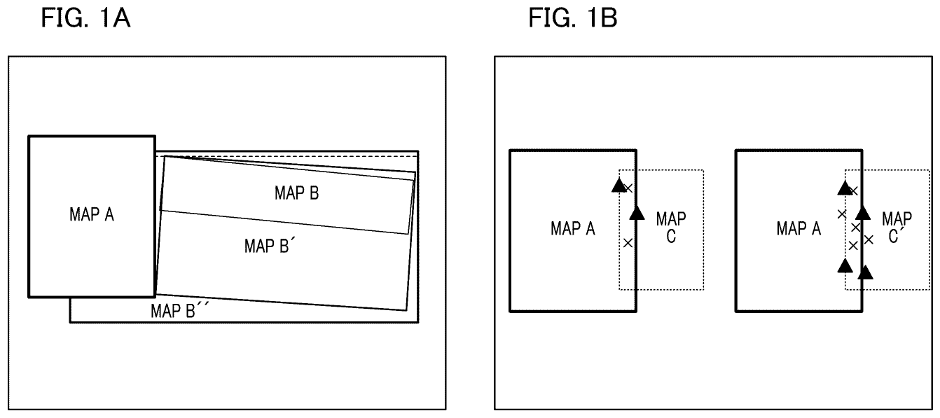

FIGS. 1A and 1B are diagrams for explaining accuracy of merging environment maps. FIG. 1A is a diagram for explaining a merging accuracy in accordance with how large/small a coupled region is (distribution in a coupling direction) when a map A and each of maps B, B′, and B″ are merged.

In FIG. 1A, the sizes of the coupled regions (distribution in the coupling direction) of the maps B, B′ and B″ with respect to the map A are in a relationship of the map B<the map B′<the map B″. The accuracies of the merged maps in this case have a relationship of (a merged map of the map A and the map B)< (a merged map of the map A and the map B′)< (a merged map of the map A and the map B″).

FIG. 1B is a diagram for explaining a merging accuracy in accordance with how large/small the numbers of feature points and key frames of the coupled regions are when the map A and each of maps C and C′ are merged. In FIG. 1B, the numbers of feature points (x marks) and key frames (A marks) in the coupled regions of the maps C and C′ with respect to the map A are in a relationship of the map C<the map C′. Accuracy of the merged maps in this case is in a relationship of (a merged map of the map A and the map C)< (a merged map of the map A and the map C′).

Therefore, a path for creating environment maps that can be merged with high accuracy is determined on the basis of information regarding image features that are similar among the environment maps in a first embodiment. In other words, a traveling path of a movable apparatus is determined such that a merging accuracy when a first environment map and a second environment map are merged is equal to or greater than a predetermined value on the basis of information regarding the second environment map. Specifically, a path when environment maps are created is determined such that the number of similar image features or a distribution level is equal to or greater than a predetermined threshold value, for example.

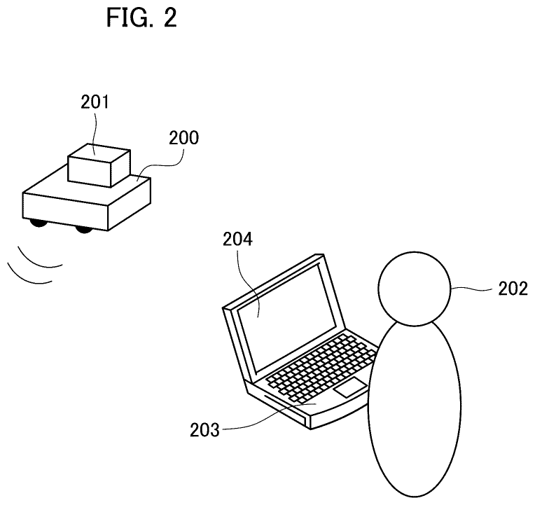

FIG. 2 is a diagram illustrating an example of a utilization scene according to the first embodiment. An automated guided vehicle (AGV), for example, as a movable apparatus 200 autonomously moves on the basis of an instruction from a terminal device 203 of a user 202, for example, and an imaging device 201 images an environment in the surroundings of the movable apparatus.

Then, a signal processing device 100 creates three-dimensional map information (environment map) of the environment. The created environment map and the determined path in the present embodiment are displayed on a display device 204 of the terminal device 203 of the user 202.

Note that the movable apparatus 200 in the present embodiment is not limited to an AGV that can autonomously move and may be in any form as long as the movable apparatus 200 is an apparatus that can move, such as an automobile, a robot, a ship, an aircraft, or a drone.

Also, it is assumed that the information processing device 300 in the present embodiment is mounted in the movable apparatus 200. However, the information processing device 300 and a storage device 302 may be mounted inside the terminal device 203, and the information processing device 300 may be configured to function by a computer program in the terminal device 203. Also, functions of the information processing device 300 and the storage device 302 may be provided as cloud services.

Additionally, the functions provided by the information processing device 300 and the like may be implemented by one or a plurality of information processing devices, a virtual machine (cloud service) using resources provided by a data center including the information processing devices, or a combination thereof.

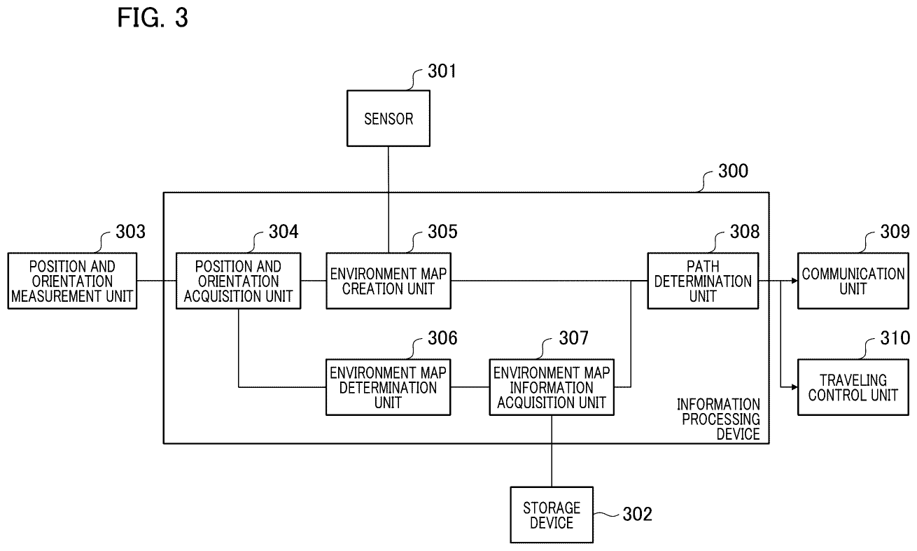

FIG. 3 is a functional block diagram illustrating a configuration example of an information processing system according to the first embodiment. Note that some of the functional blocks illustrated in FIG. 3 are realized by causing a CPU or the like as a computer included in the information processing device to execute a computer program stored in a memory as a storage medium.

However, some or all of these may be implemented by hardware. As the hardware, it is possible to use an application specific integrated circuit (ASIC), a processor (a reconfigurable process, a DSP), or the like.

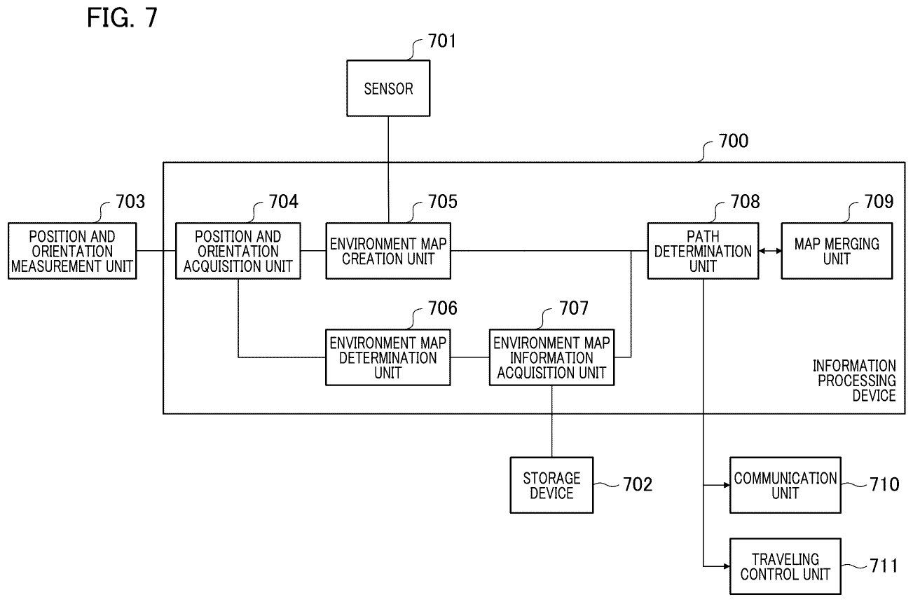

Also, the respective functional blocks illustrated in FIG. 3 may not be incorporated in the same casing and may be configured by separate devices connected to each other via a signal path. Note that the above description related to FIG. 3 also similarly applies to FIG. 7.

As illustrated in FIG. 3, the information processing system according to the first embodiment is configured of the information processing device 300, a sensor 301, the storage device 302, a communication unit 309, a traveling control unit 310, and the like. The sensor 301 is assumed to be a camera that is mounted in the movable apparatus and acquires a two-dimensional gradation image. The storage device 302 holds one or more environment maps to recognize information such as positions of objects in the surroundings and the like. Details of the environment maps will be described later.

A position and orientation measurement unit 303 measures and calculates a current position and an orientation of the movable apparatus on the basis of information acquired from the sensor 301, for example. Any method may be used as a measurement method. The information processing device 300 includes a position and orientation acquisition unit 304, an environment map creation unit 305, an environment map determination unit 306, an environment map information acquisition unit 307, a path determination unit 308, and the like.

The position and orientation acquisition unit 304 acquires current position and orientation information of the movable apparatus from the position and orientation measurement unit 303. The environment map creation unit 305 creates an environment map on the basis of the measurement information acquired by the position and orientation acquisition unit 304. Hereinafter, the environment map created by the environment map creation unit 305 will be referred to as a first environment map. Details of the environment map will be described later.

The environment map determination unit 306 determines a second environment map to be merged with the first environment map created by the environment map creation unit 305 from among the environment maps held by the storage device 302. The determination method will be described later. The environment map information acquisition unit 307 acquires the second environment map designated by the environment map determination unit 306 from the storage device 302.

The path determination unit 308 determines a moving path to create the first environment map that can be merged with the second environment map with high accuracy on the basis of the second environment map. Details of the path determination method will be described later.

The communication unit 309 transmits information regarding the traveling path and the like determined by the path determination unit 308 to the display device 204 of the terminal device 203, for example, and causes the display device 204 to display the traveling path, the environment maps, and the like. Also, the traveling control unit 310 is provided inside the movable apparatus 200 and includes a drive source such as a motor for controlling a traveling direction and a traveling operation of the movable apparatus 200 on the basis of the information such as the traveling path determined by the path determination unit 308.

The traveling control unit 310 controls traveling on the basis of the traveling path determined by the path determination unit 308.

Note that the storage device 302 of the movable apparatus may be disposed inside the information processing device 300. Also, in a case where the information processing device 300 is mounted in an external terminal, an external server, or the like, the information processing device 300 acquires information acquired by the sensor 301 via a communication interface.

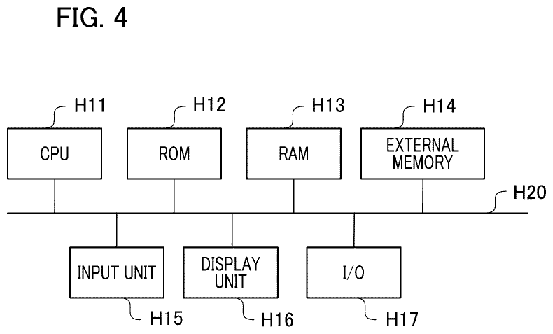

FIG. 4 is a diagram illustrating a hardware configuration example of the information processing device 300 according to the first embodiment. H11 is a CPU as a computer and executes control of various devices connected to a system bus H20 and a program processed by the information processing device 300.

H12 is a ROM and stores a program of a BIOS, a boot program, and the like. H13 is a RAM and is used as a main storage device of H11 which is the CPU. H14 is an external memory and stores a computer program and the like processed by the information processing device 300.

An input unit H15 is a keyboard, a mouse, and a robot controller and performs processing related to inputs of information and the like. In a case where the information processing device 300 also includes a display function, a display unit H16 outputs an arithmetic operation result of the information processing device 300 to a display device, which is not illustrated, in accordance with an instruction from H11.

Note that any type of the display device such as a liquid crystal display device, a projector, or an LED indicator may be used. H17 is a communication interface and performs information communication via a network, and the communication interface may be Ethernet or the like or may be a USB, serial communication, wireless communication, or the like, and any communication method may be used.

Next, an environment map will be described. The environment map is configured of a plurality of map elements. The map elements include key frames and the like in which an image captured by the sensor 301 mounted in the movable apparatus, two-dimensional positions of image feature points on the image, three-dimensional positions of the image feature points, and position and orientation information of the sensor 301 are associated.

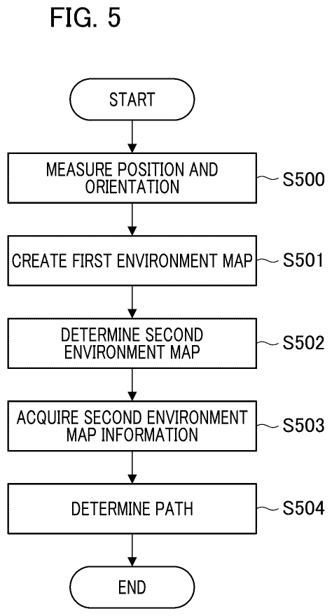

Next, FIG. 5 is a flowchart illustrating a position and orientation measurement processing example according to the first embodiment, and a processing flow in the present embodiment will be described by using FIG. 5. Note that an operation in each step of the flowchart in FIG. 5 is sequentially performed by the CPU or the like as a computer in the information processing device executing a computer program stored in the memory.

First, in Step S500, the movable apparatus acquires the current position and orientation of the movable apparatus from the position and orientation measurement unit 303 while autonomously traveling on the basis of information regarding the current position and a scheduled path. The aforementioned scheduled path is assumed to be defined on the same coordinate system as that for the environment map held by the storage device 302.

Here, Step S500 functions as a position and orientation measurement step (position and orientation measurement unit) of calculating the position and the orientation of the movable apparatus on the basis of measurement information of the sensor that measures an environment in the surroundings of the movable apparatus.

Next, in Step S501, a first environment map is created on the basis of the information measured in Step S500. The created environment map is as described above. Here, Step S501 functions as an environment map creation step (environment map creation unit) of creating the first environment map in the vicinity of the movable apparatus on the basis of the measurement information of the sensor and the position and the orientation.

Next, in Step S502, an environment map indicating an environment in the vicinity of the scheduled path of the movable apparatus is determined as a second environment map from among one or a plurality of environment maps held by the storage device 302. A method of determining the second environment map will be described later. Note that Step S502 functions as an environment map determination step (environment map determination unit) of determining the second environment map to be merged with the first environment map here.

Next, in Step S503, the second environment map designated in Step S502 is acquired from the storage device 302. Here, Step S503 functions as an environment map acquisition step (environment map acquisition unit).

Next, in Step S504, a moving path for creating the first environment map in order to enable the first environment map and the second environment map to be merged with high accuracy is determined. Here, Step S504 functions as a path determination step (path determination unit) of determining a traveling path of the movable apparatus to merge the first environment map and the second environment map on the basis of the second environment map. Details of a determination method will be described later.

Note that although Step S500 in which the movable apparatus autonomously travels has been described above, the moving path of the movable apparatus may be remotely operated from a terminal held by a user.

Next, a method of determining the second environment map performed in Step S502 will be described. A timing when the second environment map is determined may be before the movable apparatus travels along the scheduled path or may be during traveling.

In a case where the second environment map is determined before the traveling of the movable apparatus, an environment map indicating an environment in the vicinity of the scheduled path of the movable apparatus is determined as the second environment map from among one or a plurality of environment maps held by the storage device 302. In other words, an environment map indicating an environment in the vicinity of the traveling path of the movable apparatus is determined as the second environment map.

In a case where the second environment map is determined during the traveling of the movable apparatus, an environment map indicating an environment in the vicinity of the current position of the movable apparatus or in the vicinity of the scheduled path along which the movable apparatus has not yet traveled is determined as the second environment map from among one or a plurality of environment maps held by the storage device 302.

The above determination regarding whether or not the environment is in the vicinity is made on the basis of the distance between the path line of the scheduled path or the current position of the movable apparatus and the position of the camera of each key frame in each environment map held by the storage device 302.

In a case where the above distance is less than a predetermined threshold value, an environment map holding a key frame is determined as the environment map in the vicinity of the scheduled path of the movable apparatus. In a case where a plurality of environment maps indicating environments in the vicinity are determined, all of these environment maps may be determined as second environment maps, or an environment map further selected therefrom may be determined as a second environment map.

Any method may be used as the selection method. An environment map that holds a key frame with the minimum distance between the path line of the scheduled path of the movable apparatus and the key frame may be determined as a second environment map, or the user may arbitrarily designate a second environment pa from among the plurality of environment maps. In other words, it is also possible to determine the second environment map through a user's operation.

Also, in a case where there are no environment maps determined to be in the vicinity at all, the above predetermined threshold value may be lowered until there becomes one or more environment maps determined to be in the vicinity. Alternatively, a notification indicating that there are no environment maps in the vicinity may be provided to the user, and the user may be allowed to designate a second environment map.

Note that the method of determining the environment map indicating the environment in the vicinity is not limited to the above and may be another method. For example, regions including the key frame of the environment map may be determined, and whether or not the environment is in the vicinity may be determined on the basis of the distance between the positions of centers of gravity of the regions. In this case, the environment map in which the distance between the positions of the centers of gravity is less than a predetermined value is determined as an environment map in the vicinity.

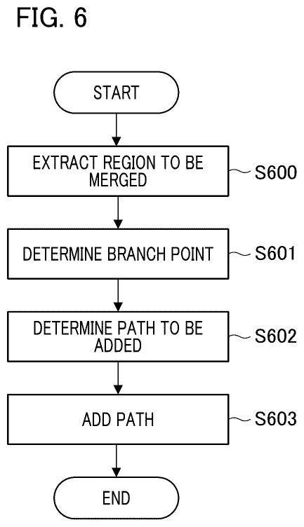

Next, FIG. 6 is a flowchart illustrating a path determination processing example according to the first embodiment, and a method of determining a path performed in Step S504 will be described using FIG. 6. Note that an operation in each step of the flowchart in FIG. 6 is sequentially performed by a CPU or the like as a computer in the information processing device executing a computer program stored in the memory.

First, in Step S600, a region where the number of image features and a spatial distribution level are greater than predetermined threshold values, respectively, is extracted as a region to be merged with the first environment map from the second environment map. A specific method of extracting the region to be merged is as follows.

First, a plurality of candidates for the region to be merged are set in the second environment map. A method of setting the candidates for the region to be merged may be any method as long as the number of key frames included in each candidate for the region to be merged is equal to or greater than a predetermined threshold value and is not limited. For example, a spatial region group with a spherical shape around each key frame at the center position is regarded as a group of candidates for the region to be merged. At this time, the radius of the region with the spherical shape is adjusted for each candidate for the region to be merged such that the number of key frames included in the candidate for the region to be merged is equal to or greater than the predetermined threshold value.

Next, a spatial distribution level of an image feature of each key frame is calculated for each candidate for the region to be merged. The spatial distribution level is, for example, a two-dimensional distribution level on the image and is calculated by performing main constituent analysis on the two-dimensional position of the image feature held by the key frame.

In other words, a predetermined first main axis and a second main axis perpendicularly intersecting the first main axis are set, for example, and σ2/σ1 which is a ratio of dispersion σ2 in the direction of the second main axis with respect to dispersion σ1 in the direction of the first main axis of the image feature of each key frame is defined as a spatial distribution level. A larger dispersion σ1 value and the ratio σ2/σ1 of the dispersion closer to 1 indicate that the image feature is widely distributed.

Next, a higher evaluation value of the calculated spatial distribution level than a predetermined value is extracted as a region to be merged from among the candidates for the region to be merged. As the evaluation value of the spatial distribution level, a sum of spatial distribution levels obtained by adding spatial distribution levels calculated for each key frame in each candidate for the region to be merged, or a statistical value such as an average or an intermediate value of the above spatial distribution levels is used. However, it is only necessary for the evaluation value of the spatial distribution level to indicate how high the spatial distribution level is, and the evaluation value is not limited to the value as described above.

In a case where a plurality of candidates for the region to be merged with higher evaluation values of spatial distribution levels than the predetermined value are present, all of these candidates may be extracted as regions to be merged, only a region to be merged with the highest spatial distribution level may be defined as a region to be merged among the candidates, or the user may arbitrarily select a region to be merged. As described hitherto, a region to be merged in the second environment map is extracted in Step S600.

Next, in Step S601, a branch point to add a new path to the scheduled path of the first environment map is determined. The branch point is defined at a position on the scheduled path of the movable apparatus in the vicinity of the region to be merged that has been extracted in Step S600, for example, a position on a scheduled path line with the minimum distance between the position of the center of gravity of the region to be merged and the scheduled path line of the movable apparatus.

Note that in a case where a plurality of regions to be merged are extracted in Step S600, the branch point in the first environment map is determined for each region to be merged. Note that the branch point may be at any position other than the above position as long as it is on the first environment map. For example, the current position may be determined as the branch point.

Next, in Step S602, a path to be merged with the second environment map with high accuracy is added to the scheduled path. The path to be added includes the branch point determined in Step S601 as a start point and an end point, and includes the vicinity of the position of each key frame in the region to be merged in the second environment map extracted in Step S600 as a passing point. Furthermore, the direction of the path at each passing point is defined as a path in the vicinity of the orientation of the key frame in the vicinity of the passing point.

Note that in a case where a plurality of regions to be merged are extracted in Step S600, a path is searched for by the above method for each region to be merged, a path to be added is selected and determined from among the plurality of paths obtained through the searching. The selection method may be any method. For example, a shortest path may be selected from among the plurality of paths obtained through the searching. Alternatively, the user may arbitrarily designate a path.

Note that in a case where a plurality of traveling paths with a merging accuracy of equal to or greater than a predetermined value are present, it is desirable to determine one traveling path on the basis of at least one of a traveling time of the traveling path, a path length of the traveling path, a merging accuracy, and a date and time of the second environment map, for example.

As described above, in regard to the key frames and the feature points held by the second environment map included in the region to be merged when the first environment map and the second environment map are merged, a traveling path may be determined on the basis of at least one of the number of key frames, distribution of the key frames, the number of image feature points, and distribution of the image feature points.

Alternatively, the traveling path of the movable apparatus may be determined such that the path length of the region to be merged when the first environment map and the second environment map are merged is equal to or greater than a predetermined value. Note that the traveling path may be determined on the basis of the positions and the orientations of the key frames held by the second environment map.

Next, in Step S603, the new path determined in Step S602 is added to the scheduled path of the movable apparatus. This is defined as a new path for the movable apparatus.

Note that the environment map held by the storage device 302 and the scheduled path of the movable apparatus are assumed to be defined in the same coordinate system and the environment map in the vicinity of the scheduled path is determined as the second environment map in Step S502 in the above description. However, the present disclosure is not limited thereto, and the environment map held by the storage device 302 and the scheduled path of the movable apparatus may be defined on separate coordinate systems.

In that case, an image that is similar to an image captured by the mounted sensor 301 while the movable apparatus is traveling along the scheduled path is searched for from the key frames of the environment maps held by the storage device 302, and an environment map found through the searching is defined as the second environment map. In a case where no corresponding environment map is found through the searching, the processing in Step S500 and Step S501 is performed for a predetermined period of time, and Step S502 is performed again.

Note that in the above example, an environment map in the vicinity of the scheduled path of the movable apparatus is determined as the second environment map from among the environment maps held by the storage device 302. However, the present disclosure is not limited to the environment map in the vicinity of the scheduled path of the movable apparatus, and an environment map arbitrarily designated by the user may be determined as the second environment map.

Note that a plurality of candidates for the region to be merged are set for a region of the second environment map, and a region with a spatial distribution level of equal to or greater than the predetermined threshold value is extracted as a region to be merged with the first environment map from among the candidates for the region to be merged in Step S600 in the above description. However, the method of extracting the region to be merged may be any method as long as a region to be merged including a large number of image features and a high spatial distribution level is extracted by the method.

For example, a region to be merged may be extracted from a route of key frames of the second environment map connected in a time-series order. Specifically, the region to be merged is extracted as follows. First, the above route is split into a plurality of sections. At this time, the route is split such that the number of key frames included in each section is equal to or greater than a predetermined threshold value. Next, a spatial distribution level in each split section is calculated.

Then, the route of a section where the evaluation value of the spatial distribution level is greater than a predetermined value is extracted as a region to be merged from all the sections. The calculation method and the evaluation value of the spatial distribution level are as described above.

The route is not limited to the above route, any route may be used as long as it can be used as a traveling route when the first environment map is created, and another expression method may be used. Note that a traveling path may be determined on the basis of route information generated on the basis of position and orientation information of the sensor measured when the second environment map is created, for example.

For example, the above route may be information indicating a three-dimensional point group indicating traveling positions when the first environment map is created and a connection relationship thereof and may be held by the first environment map. Alternatively, the above route may be information regarding a curve indicating the shape of the path of traveling at the time of the creation of the first environment map.

The spatial distribution level of the route is defined as how large the dispersions in the aforementioned first and second main axis directions are and a ratio therebetween calculated by performing main constituent analysis on a sampled point group at a predetermined interval from the three-dimensional point group on the route or the route curve.

Note that although the two-dimensional distribution level on the image is used as the spatial distribution level of the image features in Step S600 in the above description, a distribution level of three-dimensional positions of the image features may also be used. The distribution level of the three-dimensional positions of the image features is determined on the basis of dispersions σ1, σ2, and σ3 in first, second, and third main axis directions calculated by performing main constituent analysis on the three-dimensional positions of the image features. Note that the third main axis is set as a main axis that perpendicularly intersects the first main axis and the second main axis.

For example, how large the dispersion σ1 in the first main axis direction is, a ratio σ2/σ1 of the dispersion σ2 in the second main axis direction with respect to the dispersion σ1 in the first main axis direction, and a ratio σ3/σ1 of the dispersion σ3 in the third main axis direction with respect to the dispersion σ1 in the first main axis direction will be considered. A larger value of the dispersion σ1 and ratios σ2/σ1 and θ3/σ1 of dispersions closer to 1 indicate that image features are more widely distributed.

Note that although the spatial distribution level of the image features is calculated for each key frame in Step S600 in the above description, a distribution level of image features for all the key frames rather than for each key frame may be calculated. Specifically, the method described above may be applied to three-dimensional positions of image features of all the key frames to calculate the distribution level.

Note that the environment map in the vicinity of the current position or the scheduled path of the movable apparatus creating the first environment map is determined as the second environment map to be merged with the first environment map in Step S502 in the above description.

Here, the second environment map that has already been created may be used, or the second environment map that is being created by a movable apparatus 2 that is different from the movable apparatus 1 that is creating the first environment map may be used. In the case where the second environment map is being created, the environment map that is being created by the movable apparatus 2 is determined as the second environment map in a case where the current position or the scheduled path of the movable apparatus 1 is in the vicinity of the scheduled path of the movable apparatus 2.

Note that the method of determining the second environment map may be any method as long as it is possible to determine an environment map to be merged with the first environment map and is not limited. For example, the user may arbitrarily designate the second environment map.

### Modification Example 1-1

In the first embodiment, a path for merging the first and second environment maps with high accuracy is determined on the basis of the number and the spatial distribution level of the image features that are similar between the first and second environment maps. In this modification example, a method of determining a path for merging the first and second environment maps with high accuracy on the basis of how large the regions to be merged are and distribution thereof between the first and second environment maps will be described.

In a modification example 1-1, only Step S600 in the method of determining a path described using FIG. 6 is different from that described in the first embodiment, and only Step S600 will thus be described here.

First, in Step S600, a region to be merged with the first environment map is extracted from the second environment map. At this time, the region to be merged is a region where the size of the region and the spatial distribution level are equal to or greater than threshold values, respectively.

The method of extracting the region to be merged is as follows, for example. First, a route connecting positions of key frames held by the second environment map in a time-series order is created, and the route is split into a plurality of sections. At this time, the length of each section is set to be equal to or greater than a predetermined threshold value.

Next, a spatial distribution level of the route is calculated for each section. Specifically, a distribution level of positions of sensors in all the key frames that are present in each section is calculated. As the distribution level, a dispersion in each main axis direction and a ratio therebetween calculated by performing main constituent analysis on the three-dimensional positions of the sensors are defined similarly to the method described above.

Next, a section in which the spatial distribution level is equal to or greater than a predetermined threshold value is extracted. In a case where there is no section in which the spatial distribution level is equal to or greater than the threshold value, the length of each section is adjusted, and the above processing is repeated until the spatial distribution level becomes equal to or greater than the threshold value. A split section of the route extracted through the processing is extracted as a region to be merged.

Note that although the route of connecting the key frames in the time-series order is used in the above description, it is only necessary for the route to be able to be used as a traveling route when the first environment map is created, and another expression method may also be used. Similarly to the aforementioned example, the first environment map may hold information indicating a three-dimensional point group indicating a traveling position when the first environment map is created and a connection relationship thereof.

Alternatively, information regarding a curve indicating the shape of the path of traveling at the time of the creation of the first environment map may be held. As the spatial distribution level of the route, how large the dispersion in each main axis direction is and a ratio therebetween calculated by performing main constituent analysis on a sampled point group at a predetermined interval from the three-dimensional point group on the route or the route curve are defined.

### Modification Example 1-2

In the first embodiment, a path for merging the first and second environment maps with high accuracy is determined on the basis of the number and the spatial distribution level of image features that are similar between the first and second environment maps. In this modification example, a method of holding an imaging date and time of key frame images as information regarding an environment map and determining a path for merging first and second environment maps with high accuracy on the basis of the imaging date and time will be described.

Disposition of objects that are present in the environment and how the objects look like may change with time. Therefore, there is a likelihood that image features extracted from images do not completely coincide with each other when imaging dates and times are different even if the images are captured at the same position and in the same orientation.

Therefore, there is a likelihood that similar image features decrease in number between environment maps with different imaging dates and times and the environment maps cannot be merged with high accuracy. In this modification example, a method of extracting regions to be merged which have been captured at closer dates and times in order to merge the first and second environment maps with high accuracy will be described.

Since only Step S502 in the processing flow described using FIG. 5 is different from that described in the first embodiment, only Step S502 will be described here. In Step S502, a second environment map to be merged with a first environment map is determined from among one or a plurality of environment maps held by the storage device 302.

Specifically, the second environment map is determined as follows. First, environment maps holding information of key frame images captured later than a predetermined date and time are extracted from the environment maps held by the storage device 302 and are determined as second environment maps. Then, an environment map in the vicinity of the scheduled path of the movable apparatus is determined as a second environment map from among the extracted environment maps. Determination regarding whether or not the environment map is in the vicinity of the scheduled path of the movable apparatus is made similarly to that described in the first embodiment.

In the modification example 1-2, only Step S600 in the method of determining the path described using FIG. 6 is different from that described in the first embodiment, and only Step S600 will thus be described here. In Step S600, a region to be merged for merging the first environment map and the second environment map is extracted from the second environment map.

Specifically, a key frame captured later than the predetermined date and time is extracted from the second environment map, and a region including the key frame is defined as a region to be merged in the modification example 1-2. As the region including the key frame, a region within a predetermined distance range from the key frame is defined.

### Modification Example 1-3

In the first embodiment, a path for merging environment maps with high accuracy is determined on the basis of the number and the spatial distribution level of image features that are similar between the first and second environment maps.

In a modification example 1-3, a method of holding an evaluation value indicating accuracy of position and orientation measurement of each key frame as information regarding an environment map and determining a path for merging first and second environment maps with high accuracy on the basis of the evaluation value will be described.

It is possible to perform merging of maps with higher accuracy by using a key frame with high accuracy of position and orientation measurement. Specifically, it is only necessary to replace the imaging date and time with the evaluation value of the accuracy of position and orientation measurement in the method described in the modification example 1-2.

### Modification Example 1-4

In the first embodiment, the environment map is assumed to be configured by key frames in which images captured by the sensor 301 mounted in the movable apparatus, two-dimensional positions of image features on the images, three-dimensional positions of the features, and position and orientation information of the sensor 301 are associated. However, the present disclosure is not limited thereto, and it is only necessary for the environment map to hold information that can be used to estimate the position and the orientation using SLAM.

For example, it is possible to estimate the position and the orientation of the sensor on the basis of information of each pixel value on an image instead of image features in SLAM as disclosed in Literature 1 (Richard A. Newcombe. Steven J. Lovegrove and Andrw J. Davison, DTAM: Dense Tracking and Mapping in Real-Time, ICCV 2011).

In that case, captured images, the position and the orientation of the sensor, cumulative error information of pixel values are held as key frames. Then, a depth value of each pixel is estimated on the basis of the cumulative error information of the pixel value.

At this time, the depth value may not be able to be calculated for a pixel with a small difference from pixel values in the surroundings. Therefore, in a modification example 1-4, the flow described using FIG. 6 is performed by replacing the number of image features with the number of pixels for which depth values can be estimated and replacing the spatial distribution of the image features with a spatial distribution of the depth values.

Also, the environment map may hold, instead of the key frames, three-dimensional shape information of objects disposed in the environment. The three-dimensional shape information may be three-dimensional point group information or may be three-dimensional plane group information that is called a polygon.

In that case, the position and the orientation of the key frame described in the first embodiment are replaced with an arbitrary position and orientation that enables observation of the above three-dimensional shape. As for the arbitrary position and orientation, a three-dimensional spherical surface or a two-dimensional circle with a predetermined radius around the above three-dimensional shape at the center position is split into a plurality of grids, and a position and an orientation of each of points of the split grids is set to observe the center position from the position, for example.

### Modification Example 1-5

In the first embodiment, the sensor 301 is a camera that acquires a gradation image. The sensor 301 is not limited thereto and may be a distance sensor such as a light detection and ranging (LiDAR).

Two-dimensional point group information in a case of a two-dimensional lidar or three-dimensional point group information in a case of a three-dimensional lidar is acquired, and information obtained by associating the point group information with the position and the orientation at the time of measurement is used as the environment map. Also, it is only necessary to replace the image features in the method described in the first embodiment with the two-dimensional or three-dimensional point group information.

### Second Embodiment

In the first embodiment, the method of determining a path of the movable apparatus to achieve a higher merging accuracy on the basis of information common to environment maps has been described. In a second embodiment, a method of actually merging environment maps and determining (changing) a path of a movable apparatus on the basis of a merging accuracy will be described.

FIG. 7 is a functional block diagram illustrating a configuration example of an information processing system according to the second embodiment. The information processing system in the second embodiment is configured by an information processing device 700, a sensor 701, a storage device 702, a communication unit 710, a traveling control unit 711, and the like.

The communication unit 710 transmits information such as a traveling path determined by a path determination unit 708 to a display device 204 or the like of a terminal device 203, for example, and causes the display device 204 to display the traveling path, an environment map, and the like. Also, the traveling control unit 711 is provided inside a movable apparatus 200 and includes a drive source such as a motor for controlling a traveling direction and a traveling operation of the movable apparatus 200 on the basis of the information such as the traveling path determined by the path determination unit 708.

Note that although an example in which the information processing device 700, the storage device 702, and the like are mounted in the movable apparatus will be described in the second embodiment as well, functions of the information processing device 700 and the storage device 702 may be provided as cloud services.

In other words, the functions provided by the information processing device 700 and the like may be realized by one or a plurality of information processing devices, a virtual machine (cloud service) using resources provided by a data center including an information processing device, or a combination thereof.

Since the sensor 701, the storage device 702, and the position and orientation measurement unit 703 are similar to the sensor 301, the storage device 302, and the position and orientation measurement unit 303 described in the first embodiment, description will be omitted. The information processing device 700 is configured by a position and orientation acquisition unit 704, an environment map creation unit 705, an environment map determination unit 706, an environment map information acquisition unit 707, a path determination unit 708, a map merging unit 709, and the like.

Only the map merging unit 709 is different from among the components described in the first embodiment, and only the map merging unit 709 will thus be described here. The map merging unit 709 functions as an environment map merging unit that merges a first environment map and a second environment map. A merging method will be described later.

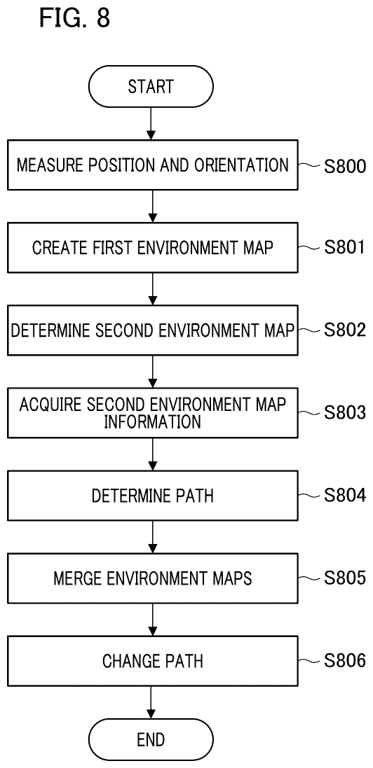

Next, FIG. 8 is a flowchart illustrating a path determination processing example according to the second embodiment, and a processing flow in the second embodiment will be described using FIG. 8. Note that an operation in each step of the flowchart in FIG. 8 is sequentially performed by a CPU or the like as a computer in the information processing device executing a computer program stored in a memory.

Note that only Steps S805 and S806 are different from those in the processing flow in FIG. 5 described in the first embodiment, and only Steps S805 and S806 will thus be described here.

In Step S805, a first environment map and a second environment map are merged. A merging timing may be during traveling along the path additionally determined in Step S804 or after traveling along the additionally determined path. A merging method will be described later.

In Step S806, the path is changed on the basis of the implementation timing of the merging of the environment maps performed in Step S805 and a merging accuracy. Here, Step S806 functions as a path changing step (path changing unit) of changing the traveling path on the basis of the merging accuracy of the environment maps merged by the map merging unit 709 as an environment map merging unit. Details of the method of changing the path will be described later.

Next, a method of merging the first environment map and the second environment map performed by the map merging unit 709 in Step S805 will be described. First, in a case where the first environment map including the scheduled path of the movable apparatus is not defined on the same coordinate system as that of the second environment map, a position and an orientation of each key frame in the first environment map are converted into those on the coordinate system of the second environment map.

The conversion is performed by applying a relocalization technique described in Literature 2 (M. A. Raul, ORB-SLAM: A Versatile and Accurate Monocular SLAM System, 2015), for example, using the key frames in the second environment map similar to the captured image of the movable apparatus.

Next, bundle adjustment is performed using information regarding the key frames in the first and second environment maps, and the position and the orientation of a first key frame are calculated again.

The bundle adjustment is processing of measuring the position and the orientation of the sensor at which a sum (residual) of differences between the positions of projection points obtained by projecting three-dimensional positions of image features held by the key frames to the captured image and image feature positions detected from the captured image of the sensor is the minimum. In regard to the bundle adjustment, it is only necessary to use the method described in Literature 2 described above, and detailed description will thus be omitted.

Next, a method of changing the path performed in Step S806 will be described. In Step S806, the path is changed on the basis of the timing of the merging of the environment maps performed in Step S805 and the merging accuracy.

The timing of the merging of the environment maps is either during the traveling along the path additionally determined in Step S804 or after the traveling. As the merging accuracy of the environment maps, an error of the bundle adjustment performed in Step S805 is used. In other words, a smaller error indicates higher accuracy.

During the traveling along the added path and in a case where the error of the bundle adjustment is less than a predetermined threshold value, or after the traveling along the added path and in a case where the error of the bundle adjustment is equal to or greater than the predetermined threshold value, the path is changed to a new path. As the new path, a path to a destination set by a user or the shortest path to return to the original scheduled path before the path is additionally determined in Step S804 is used for the former case. Note that the new path is not limited to the above path and may be any path as long as the movable apparatus can travel along the path.

On the other hand, in the latter case, the method described in the first embodiment is applied, and a path that can be merged with the second environment map with high accuracy is newly added. At this time, the region to be merged that has already been used as an added path when the region to be merged is extracted in Step S804 is excluded from extraction targets.

Also, in calculation of a spatial distribution level of image features, a route, and the like performed in the extraction of the region to be merged, the image features and the route of the region to be merged which have already been used as the added path are also included in the calculation. In this manner, it is possible to improve a merging accuracy of the environment maps by adding another path even in the case where the merging accuracy of the environment maps does not reach desired accuracy after the traveling along the added path.

Although the merging accuracy of the environment maps is an error of the bundle adjustment in the above description, any method may be used as long as it is possible to determine how good or poor the merging is. For example, a traveling path of an environment geographical map or an environment map defined on a CAD drawing may be defined as correct answer data and a level of consistency with the correct answer data may be used as a merging accuracy.

As for the level of consistency, a point group sampled on the traveling path as the correct answer data and a sensor position of a key frame group in the environment map after the merging are positioned (registrated) by using a method called iterative closest point (ICP), and an error therebetween is used. In this case, a smaller error is determined to mean a higher level of consistency.

The level of consistency is not limited thereto and may be calculated by another method. A difference between shapes or volumes of a rectangular parallelepiped shape including the traveling path that is correct answer data and a rectangular parallelepiped shape including a sensor position in the key frame group after the merging may be used as the level of consistency.

### Modification Example 2-1

In the second embodiment, the environment map is assumed to be configured by key frames in which the images captured by the sensor 701 mounted in the movable apparatus, the two-dimensional positions of the image features on the image, the three-dimensional positions of the image features, and the position and orientation information of the sensor 701 are associated. However, the present disclosure is not limited thereto, it is only necessary for the environment map to hold information that can be used to estimate the position and the orientation using SLAM, and the environment map is not limited.

As disclosed in Literature 1, for example, it is possible to estimate the position and the orientation of the sensor on the basis of information regarding each pixel value on the image instead of the image features in the SLAM. It is possible to hold the captured images, the position and the orientation of the sensor, and pixel value cumulative error information as the key frames and to estimate a depth value of each pixel on the basis of the pixel value cumulative error information.

Therefore, the position and the orientation and the depth value of the key frames are estimated such that the pixel value cumulative error becomes its minimum in the processing of merging the environment maps described in Step S805 in the modification example 2-1. Also, in the processing of changing the path performed in Step S805, the size of the pixel value cumulative error is determined as a merging accuracy.

Also, the environment map may hold three-dimensional shape information instead of the key frames. The three-dimensional shape information may be three-dimensional point group information or may be three-dimensional plane group information that is called a polygon.

In this case, positioning (registration) of three-dimensional shapes is performed using the aforementioned method of ICP and merging is performed in the processing of merging the environment maps described in Step S805. Also, the size of the error in the positioning (registration) using ICP performed in Step S805 is determined as a merging accuracy in the processing of changing the path performed in Step S605.

### Modification Example 1-5

In the second embodiment, the sensor 301 is a camera that acquires a gradation image. The sensor 301 is not limited thereto and may be a distance sensor such as a lidar. The environment map is assumed to be information in which two-dimensional point group information in a case of a two-dimensional lidar, three-dimensional point group information in a case of a three-dimensional lidar, and the position and the orientation at the time of measurement are associated.

In this case, positioning (registration) between point groups is performed using ICP and merging is performed in the processing of merging the environment maps described in Step S805. Also, the size of the error in positioning (registration) using ICP performed in Step S805 is determined as a merging accuracy in the processing of changing the path performed in Step S805.

### Third Embodiment

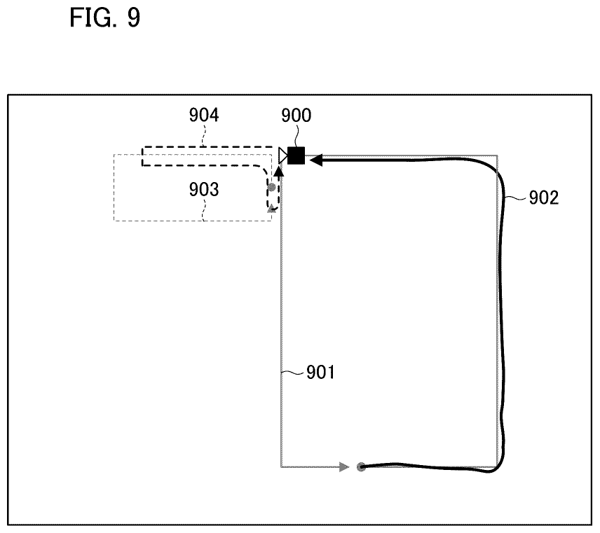

In the first embodiment and the second embodiment, the method for determining a path to merge environment maps has been described. In a third embodiment, an example in which the determined path is presented to a user will be described. FIG. 9 is a diagram illustrating an example of a screen showing an environment map to be merged and information regarding a traveling path added for merging in the third embodiment.

FIG. 9 illustrates a current position 900 of a movable apparatus, a scheduled path 901 of the movable apparatus, a route 902 along which the movable apparatus has already traveled, an environment map (second environment map) 903 as a target of merging, and a determined added path 904.

A user can check that a new path has been added to the scheduled path of the movable apparatus and the environment map as a target of merging through display of the information using lines with different types or colors. Note that in a case where there are a plurality of candidates for the path to be added, information regarding the candidates for the path to be added may be displayed to allow the user to make selection.

The information regarding the candidates for the path to be added may be any information related to the path to be added and may be, for example, the length of the path, the number and the value of the spatial distribution level of image features described in Step S600 in the first embodiment, or the like.

Any device may be used to display the screen as long as an operator, an administrator, or the like can view the screen and may be, for example, the terminal device 203 of the user 202 illustrated in FIG. 2. Alternatively, the screen may be displayed on a display device installed in the movable apparatus.

While the present disclosure has been described with reference to embodiments, it is to be understood that the disclosure is not limited to the disclosed embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing device or the like through a network or various storage media. Then, a computer (or a CPU, an MPU, or the like) of the information processing device or the like may be configured to read and execute the program. In such a case, the program and the storage medium storing the program configure the present disclosure.

In addition, the present disclosure includes those realized using at least one processor or circuit configured to perform function of the embodiments explained above, for example. Distributed processing may be performed using a plurality of processors.

This application claims the benefit of priority from priority from Japanese Patent Application No. 2023-059808, filed on Apr. 3, 2023, which is hereby incorporated by reference herein in its entirety.

What is claimed is:

1. An information processing device comprising at least one processor or circuit configured to function as:
a position and orientation measurement unit configured to calculate a position and an orientation of a movable apparatus based on measurement information of a first sensor that measures an environment in surroundings of the movable apparatus;
an environment map creation unit configured to create a first environment map in a vicinity of the movable apparatus based on the measurement information of the first sensor and the position and the orientation;
an environment map determination unit configured to determine a second environment map to be merged with the first environment map;
an environment map acquisition unit configured to acquire information regarding the second environment map; and
a path determination unit configured to determine a traveling path of the movable apparatus to merge the first environment map and the second environment map based on the information regarding the second environment map.

2. The information processing device according to claim 1, wherein the environment map determination unit determines, as the second environment map, an environment map indicating an environment less than a predetermined distance from the traveling path of the movable apparatus.

3. The information processing device according to claim 1, wherein the environment map determination unit determines the second environment map in accordance with an operation of a user.

4. The information processing device according to claim 1, wherein the path determination unit determines the traveling path such that a merging accuracy when the first environment map and the second environment map are merged is equal to or greater than a predetermined value, based on the information regarding the second environment map.

5. The information processing device according to claim 1, wherein in a case where a plurality of the traveling paths with a merging accuracy of equal to or greater than a predetermined value is present, the path determination unit determines one of the traveling paths based on at least one of a traveling time of the traveling path, a path length of the traveling path, the accuracy of merging, and a date and time of the second environment map.

6. The information processing device according to claim 1, wherein in key frames and feature points held by the second environment map are included in a merged region when the first environment map and the second environment map are merged, and the path determination unit determines the traveling path based on at least one of a number of the key frames, a distribution of the key frames, a number of the feature points, and a distribution of the feature points.

7. The information processing device according to claim 1, wherein the path determination unit determines the traveling path such that a path length of a merged region when the first environment map and the second environment map are merged is equal to or greater than a predetermined value.

8. The information processing device according to claim 1, wherein the environment map determination unit determines, as the second environment map, an environment map holding information from later than a predetermined date and time.

9. The information processing device according to claim 1, wherein the path determination unit determines the traveling path based on positions and orientations of key frames held by the second environment map.

10. The information processing device according to claim 1, wherein the path determination unit determines the traveling path based on route information created based on position and orientation information of a second sensor measured when the second environment map is created.

11. The information processing device according to claim 1,
wherein the at least one processor or circuit is further configured to function as
an environment map merging unit configured to merge the first environment map and the second environment map, and
a path changing unit configured to change the traveling path based on a merging accuracy of the environment maps merged by the environment map merging unit.

12. A movable apparatus comprising at least one processor configured to function as:
a position and orientation measurement unit configured to calculate a position and an orientation of the movable apparatus based on measurement information of a first sensor that measures an environment in surroundings of the movable apparatus;
an environment map creation unit configured to create a first environment map in a vicinity of the movable apparatus based on the measurement information of the first sensor and the position and the orientation;
an environment map determination unit configured to determine a second environment map to be merged with the first environment map;
an environment map acquisition unit configured to acquire information regarding the second environment map;
a path determination unit configured to determine a traveling path of the movable apparatus to merge the first environment map and the second environment map based on the information regarding the second environment map; and
a traveling control unit configured to control traveling based on the traveling path.

13. An information processing method comprising:
calculating a position and an orientation of a movable apparatus based on measurement information of a first sensor that measures an environment in surroundings of the movable apparatus;
creating a first environment map in a vicinity of the movable apparatus based on the measurement information of the first sensor and the position and the orientation;
determining a second environment map to be merged with the first environment map;
acquiring information regarding the second environment map; and
determining a traveling path of the movable apparatus to merge the first environment map and the second environment map based on the information regarding the second environment map.

14. A non-transitory computer-readable storage medium configured to store a computer program comprising instructions for executing following processes:
calculating a position and an orientation of a movable apparatus based on measurement information of a first sensor that measures an environment in surroundings of the movable apparatus;
creating a first environment map in a vicinity of the movable apparatus based on the measurement information of the first sensor and the position and the orientation;
determining a second environment map to be merged with the first environment map;
acquiring information regarding the second environment map; and
determining a traveling path of the movable apparatus to merge the first environment map and the second environment map based on the information regarding the second environment map.
